(19) United States
(12) Patent Application Publication
(10) Pub. No.: US 2023/0267385 A1
(43) Pub. Date: Aug. 24, 2023

(54) FORECASTING GROWTH OF AQUATIC ORGANISMS IN AN AQUACULTURE ENVIRONMENT

(71) Applicant: Aquabyte, Inc., San Francisco, CA (US)

(72) Inventors: Bryton SHANG, San Francisco, CA (US); Alok SAXENA, San Francisco, CA (US)

(21) Appl. No.: 17/678,440

(22) Filed: Feb. 23, 2022

(51) Int. Cl. G06Q 10/04; G06N 20/00

(52) U.S. Cl. CPC G06Q 10/04; G06N 20/00

(57) ABSTRACT

Computer-implemented techniques for forecasting growth of a set of aquatic organisms in an aquaculture environment using time-series models. The techniques can be used to predict the growth of a set of aquatic organisms in a fish farm enclosure in a period. In some variations, the techniques proceed by obtaining an evidentiary time series (e.g., daily biomass estimates produced by a biomass estimation system) and a set of one or more reference (covariant) time series (e.g., daily biomass estimates produced by a biological model of fish growth). The techniques construct a time-series model from the evidentiary time series and the set of reference time series. The techniques use the constructed time-series model to forecast the evidentiary time series. In some variations, the time-series model is a Bayesian structural time-series model or other state space model for time series data.

### BACKGROUND

The disclosed subject matter relates to computer-implemented techniques for forecast growth of aquatic organisms in an aquaculture environment.

Aquaculture is the farming of aquatic organisms such as fish in both coastal and inland areas involving interventions in the rearing process to enhance production. Aquaculture has experienced dramatic growth in recent years. The United Nations Food and Agriculture Organization has estimated that aquaculture accounts for at least half of the world's fish that is used for food.

The rise of aquaculture has fostered interest in techniques that improve the production processes in fish farms. Along the same lines, there is interest in biomass estimation techniques that can help fish farmers adjust feed and medicine amounts and composition, detect fish loss, and determine the best time to harvest.

Traditional techniques to estimate fish biomass involve manual sampling and weighing. However, minimizing the handling of fish is highly desirable not just because it is human-labor intensive but also because it impacts the health of the fish. As such, less invasive techniques are preferred.

Current biomass estimation systems use computer vision techniques to detect fish in video captured by a camera immersed underwater in a net pen or other fish farming enclosure. Certain methods to detect fish include either having a human click on the fish in a video image or using an algorithm such as a deep artificial neural network-based computer vision algorithm to detect fish in the video frames. Once a fish is detected, its biomass can be estimated either as a simple count or by its weight as estimated by dimensional information (e.g., fork length) about the fish derived from the video of the fish.

There can be significant measurement noise in biomass estimates produced by computer vision-based biomass estimation systems. It is difficult or impractical to account for all the sources of measurement noise. In addition, there can be substantial sampling bias in the biomass estimates produced by conventional systems. Typically, for cost reasons, a single camera is used. The size of the fish farming enclosure is such that a single camera cannot capture sufficiently high-quality video of all fish in the enclosure at once. Thus, a sample of some of the fish in the enclosure is typically captured. An estimate of the biomass of all fish in the enclosure may then be extrapolated from the sample. Depending on how representative the fish of the sample are of all fish in the enclosure, the estimate may reflect substantial sampling bias.

Accordingly, there is a need for techniques that enhance performance in estimating biomass of aquatic organisms in aquaculture environments.

### BRIEF DESCRIPTION OF DRAWINGS

In the drawings:

FIG. 1 depicts an example process for forecasting growth of aquatic organisms in an aquaculture environment.

FIG. 2 depicts an example system for forecasting growth of aquatic organisms in an aquaculture environment.

FIG. 3 depicts example hardware and configurations for forecasting growth of aquatic organisms in an aquaculture environment.

### DETAILED DESCRIPTION

Computer-implemented techniques for forecasting growth of a set of aquatic organisms in an aquaculture environment using time-series models are provided. For example, the techniques can be used to predict the growth of a set of aquatic organisms in a fish farm enclosure (e.g., a net pen) in a period (e.g., the next day or the next week). Accurately answering a question like this can be difficult when biomass estimation systems produce noisy or biased biomass estimates.

In some variations, the techniques can proceed by obtaining an evidentiary time series (e.g., daily biomass estimates produced by a biomass estimation system) and a set of one or more reference (covariant) time series (e.g., daily biomass estimates produced by a biological model of fish growth). The techniques can construct a time-series model from the evidentiary time series and the set of reference time series. The techniques can use the constructed time-series model to forecast the evidentiary time series. In some variations, the time-series model can be a Bayesian structural time-series model or other state space model for time series data.

In some variations, the techniques can be used to determine the effect of an intervention in the rearing process (e.g., a change in feed amount or composition) or the effect of an event in the aquaculture environment (e.g., sea lice infestation) on the growth of the set of aquatic organisms. Although not required, in this case, the set of reference time series can be selected such that they are not affected by the intervention or the event so as not to underestimate or overestimate the effect or falsely conclude that the intervention or the event had an effect.

In some variations, to determine the effect of an intervention or an event on the growth of the set of aquatic organisms, the techniques can divide the evidentiary time series into two periods referred to herein as the prior period and the posterior period. For example, the point in time that divides the evidentiary time series into the two periods can correspond to just before the intervention was taken or just before the event is suspected to have occurred. The techniques can construct a time-series model from the evidentiary time series and the set of reference time series during the prior period. The techniques can use the constructed time-series model to forecast how the evidentiary time series would have evolved if the intervention was not taken or if the event did not occur. The difference between evidentiary time-series and the forecast during the posterior period can represent the effect of the intervention or the effect the event on the growth of the aquatic organisms. Depending on the extent of the effect, various actions can be taken. For example, an operator of the aquaculture environment can be presented with a computer graphical user interface that indicates whether the intervention or the event probably had an impact of the growth of the set of aquatic organisms.

Example Process

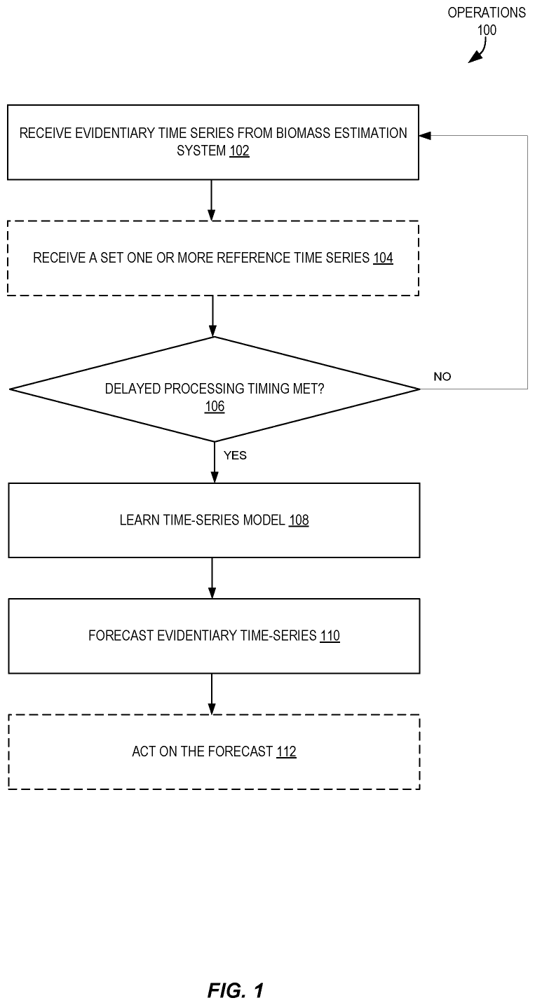

FIG. 1 illustrates a process for forecasting growth of aquatic organisms in an aquaculture environment. In summary, the process can proceed by receiving 102 an evidentiary time series from a biomass estimation system. Optionally, a set of one or more reference time series can also be received 104. The evidentiary time series and the set of reference time series can be received during a delayed processing window. Once the delayed processing window has ended, a time series model can be learned 108 from the evidentiary time series and the set of references time series can be received 102, 104 during the delayed processing window. The learned time series model can then be used to forecast 110 the evidentiary time series for a period. In some variations, the process can continue by acting 112 on the forecast.

As an example, consider the batch processing of biomass estimates of fish in a fish farming enclosure as determined by a biomass estimation system. These biomass estimates might be determined by the biomass estimation system over a prior period such as, for example, a past day, week, or month. Process 100 can be used to forecast the biomass estimates over a posterior period such as, for example, the next day, week, or month. The forecast can influence a variety of decisions in the rearing process. For example, the forecast can be used as input for feed dosage calculation or feed formulation to determine a dosage or formulation designed to maintain or increase the fish growth rate. In addition to being useful for feed dosage and formulation optimization, the forecast can be useful for determining optimal harvest times and maximizing sale profit for fish farmers. For example, fish farmers can use the forecast to determine how much of different fish sizes they can harvest and bring to market. The different fish sizes can be distinguished in the market by 1-kilogram increments. The forecast can be used to determine which market bucket (e.g., the 4 kg to 5 kg bucket, the 5 kg to 6 kg bucket, etc.) the fish in fish farming enclosure will belong to. The forecasts can also improve fish farmers' relationships downstream in the market such as with slaughterhouse operators and fish futures markets. The forecast can also be useful for compliance with governmental regulations. For example, in Norway, a salmon farming license can impose a metric ton limit. The forecast can be useful for ensuring compliance with such licenses.

In many of the examples herein, the aquatic organisms are Atlantic salmon. In some variations, the aquatic organisms are other species of fish. For example, the aquatic organisms can be for example, Grass carp, Silver carp, Common carp, Nile tilapia, etc.

Reference is made herein to a “prior” period and a “posterior” period. The start of the prior period can typically be earlier in time than the end of the posterior period. While the posterior period can encompass a future period, there is no requirement that this be the case. For example, the posterior period or a first portion thereof can be in the past. For example, the posterior period can be selected to conduct a what-if analysis using techniques disclosed herein to assess the impact of a past intervention or a past event on the growth of the aquatic organisms in the aquaculture environment.

Returning to the top of process 100, an evidentiary time series is received 102 for a prior period. Receiving the time series data can take any appropriate form. In some variations, data can be received from a biomass estimation system, can be received by another process, function within the same system, can be received in a shared memory space, such as a database, directory, etc. For example, a computer vision-based biomass estimation can have previously estimated the biomass of the fish in a fish farming enclosure daily for the past few months and time series data can be received 102 indicating the biomass estimate for each day. The biomass estimates and associated periods can be stored in attached storage, cloud storage, or a storage level local to the receiving system, or in any other appropriate location.

Associating received 102 biomass estimates with periods can include using an attribution for previous biomass estimates made. This can be important when it might otherwise be ambiguous what biomass estimate was associated with the received 102 evidentiary time series. For example, if the biomass estimation system makes multiple biomass estimates for a period (e.g., biomass estimates of different individual fish for a day), then it can be difficult to know to which period to attribute any received 102 biomass estimates. In some variations, attribution is done by attributing only biomass estimates made for a particular period to the particular period. For example, if the particular period is a particular day, then biomass estimates made for the particular day would be attributed to that day. As another example, if only one biomass estimate is made for a particular period, then that biomass estimate may be attributed to the particular period.

Evidentiary time series data can be received 102 in one form and stored in another form. In some variations, the received evidentiary time series can be an indication of a set of biomass estimates made by a biomass estimation system for a set of corresponding periods. The stored evidentiary time series can represent the biomass estimates and corresponding periods numerically or in any appropriate form. For example, the evidentiary time series and any reference time series can be stored as a vector, or matrix, a data frame, or other appropriate time series representation. In some variations, the stored representation has rows and columns where the rows correspond to different time points (e.g., different days) and the columns correspond to different time series where a first column contains the biomass estimates of the evidentiary time series and other columns contain the biomass estimates of any reference time series.

At optional step 104, a set of one or more reference time series are received. A reference time series can be received 104 in the same manner as the evidentiary time series is received 102. However, a reference time series can be preferably received 104 spanning both the prior period and the posterior period. The portion of the reference time series for the prior period can be used to learn the time series model. The portion of the reference time series for the posterior period can be used to forecast the evidentiary time series for the posterior period using the learned time series model. If some or all the posterior period is in the future, then biomass estimates of that portion or all of the reference time series corresponding to the future can be predicted, estimated, extrapolated, synthetically generated, or otherwise provided.

In some variations, a reference time series is not affected by interventions or events that affect the evidentiary time series. For example, a reference time series can reflect biomass estimates determined by a biomass estimation system for a different fish farm enclosure (e.g., a different net pen) than the fish farm enclosure for which the biomass estimates of the evidentiary time series is determined. As another example, a reference time series can be a synthetically generated time series such as one that reflects an optimal or ideal growth pattern. As yet another example, a reference time series can be generated according to a biological model of fish growth. For example, in the case of farmed Atlantic salmon, the biological model can be the dynamic energy budget organization described in the paper: Kooijman, B. (2009). Dynamic Energy Budget Theory for Metabolic Organisation (3rd ed.). Cambridge: Cambridge University Press.

A reference time series can be generated according to a feed-based model of fish growth. For example, the model can be dependent on the type of feed, the amount of feed, and the nutrient composition in the feed. In addition, the model can be dependent on environment conditions in the aquaculture environment such as water temperature, salinity, etc. The model can be generated from historical data of different aquaculture environments. Such a model forms a basic measuring guide on expected fish feed intake, fish growth, and fish health.

In some variations, the set of reference time series includes tens or hundreds of reference time series. Only some of the reference time series can be informative to the forecast. Specifically, when the time series model is learned 108, an appropriate subset of the set of reference time series can be selected to use in the learned 108 model. For example, a spike and slab prior can be placed over coefficients when learning 108 the model.

In some variations, the evidentiary time series can be missing biomass estimates for some time points. In this case, a forecast can still be made. In some variations, a reference time series is not missing any biomass estimates. In some variations, if a reference time series is missing one or more biomass estimates for certain time points, then the missing biomass estimates can be estimated (e.g., interpolated from other biomass estimates of the reference time series).

If the delayed process (or batch) timing has not been met 106, then process 100 can continue to collect evidentiary time series data and possibly reference time series data until the timing is met 106 (as depicted by the arrow from 106 to 102). In some variations, the delayed process timing is not met during a “batch window.” The delayed process or batch window timing can be any appropriate time period, such as one day, a few days, one week, one month, etc. In some variations, meeting 106 the batch timing can include the passage of a particular amount of time since the end of the previous delayed process period, or can be met by a certain real-world time (e.g., every 24 clock hours or at midnight, etc.). In some variations, meeting the batch timing can also include receiving 102 biomass estimates for a predetermined number of time points. For example, in order to meet 106 the delayed processing timing, both a particular amount of time has to have passed and biomass estimates for a certain number of time points have to be received 102. In some embodiments, meeting 106 the delayed batch timing can include only receiving 102 biomass estimates for a certain number of time points, without a requirement for the passage of a certain amount of time.

Returning to the fish farming example, biomass estimates for a particular fish farm enclosure (e.g., a particular net pen) can be received 102 until a delayed processing timing is met 106. The timing might be met 106 when a one-week period has elapsed. Before that timing is met 106, more biomass estimates can continue to be received 110.

If the delayed process (or batch) timing is met 106, then process 100 can proceed by learning 108 a new time series model based on the evidentiary time series data received 102. In some variations, determining the new time series model can include fitting a Bayesian structural time series model, or other state space model for time series data, to the evidentiary time series and set of reference time series, if any. Generally speaking, a state space model for time series data can be defined by an observation equation and a state equation. The observation equation can link observed data (e.g., the evidentiary time series data) to a state vector. The state equation can govern the evolution of the state vector through time.

In some variations, the state equation incorporates components of state such as a local linear trend model and a seasonality model. The referenced time series can be included in the time series model through a linear regression with static or time-varying (dynamic) coefficients the choice of which depends on a desired tradeoff between capturing local behavior and accounting for regression effects. In some variations, linear regression with static coefficients is used where the relationship between the evidentiary time series and the set of reference times reference has exhibited periods of stability in the past. More information on Bayesian structural time series model can be found in the paper by Kay H. Broderson et al.; Inferring Causal Impact Using Bayesian Structural Time-Series Models; The Annals of Applied Statistics 2015; Vol. 9, No. 1, pp. 247-274.

While in some embodiments a Bayesian structural time series model is learned by fitting the model to the evidentiary time series and set of reference time series, if any, a Kalman filtering model or other state space model for time series forecasting may be used is learned by fitting the model to the evidentiary time series and set of reference time series, if any.

In some variations, the seasonal component is not used in the state equation when learning 108 the time series model. This may be because the evidentiary time series and the set of reference time series may reflect all or a portion of a single growth cycle from stocking to harvest.

At operation 110, the time series model learned 108 is used to forecast the evidentiary time series for the posterior period. The portion of the evidentiary time series from which model is learned 108 corresponds to the prior period. In some variations, forecasting the evidentiary time series for the posterior period includes conducting a posterior simulation based on simulating draws of parameters of the learned 108 time series model and the state vector based on the evidentiary time series for the prior period. For example, a Gibbs sampler can be used to simulate a sequence from a Markov chain with a stationary distribution. Forecasting the evidentiary time series for the posterior period can also include using the posterior simulations to simulate from the posterior predictive distribution over the forecasted evidentiary time series based on the evidentiary time series for the prior period.

In some variations, the length of the posterior period is equal to the length of the prior period. For example, if the prior period is one month, then the forecast may be for the next month. However, the prior period can be longer than the posterior period. For example, the prior period may be one month, and the forecast may be for the next day or the next week. In some variations, the length of the posterior period for which to forecast the evidentiary time series is specified as a user parameter. In some variations, the length of the prior period from which to learn 108 the time series model is specified as a user parameter. In some variations, the length of posterior period is specified in terms of a number of time points to forecast in the evidentiary time series. For example, if the prior period corresponds to sixty time points of the evidentiary time series where each time point represents one day, then a posterior period of seven time points would represent seven days of forecast.

In some variations, the forecast includes a set of data values for each time point of the posterior period. The set of data values can include the posterior mean of the forecasted biomass estimate for the time point, the lower limit of a posterior interval for the time point, and the upper limit of the posterior interval for the time point. For example, the posterior intervals for the forecast can be 99%, 95%, 90%, etc. intervals.

At operation 112, an action can be taken based on the forecast 110 made. In some variations, a plot is presented to a user in a graphical user interface. The plot can chart the evidentiary time series during the prior period and the forecast during the posterior period as a function of time. For example, the y-axis of the plot can represent time and the x-axis of the plot can represent biomass of the set of aquatic organisms in the net pen. From the plot, a user can see if the forecasted growth is as expected. For example, from the plot, a user can determine from the forecast that the set of aquatic organisms will probably be ready for harvest by an expected date. The plot can include the posterior mean of the forecasted biomass estimates for each time point in the posterior period as well the posterior intervals for each of the biomass estimates.

In some variations, the evidentiary time series obtained from a biomass estimation system and any reference time series are divided into the prior period and the posterior period corresponding to when an intervention in the rearing of the set of aquatic organisms was taken or when an event that may have affected the growth of the set of aquatic organisms is suspected to have occurred. For example, the time points of the evidentiary time series and the reference time series can be divided into the prior period and posterior period based on a selected time point. In this case, as above, the time series model is learned 108 from the biomass estimates of the evidentiary and any reference time series in the prior period and the learned 108 model can be used to forecast 110 biomass estimates of the evidentiary time series based on the biomass estimates of the reference times series in the posterior period. However, the actual evidentiary time series for the posterior period as determined by the biomass estimate system can be available. Thus, the actual evidentiary time series for the posterior period can be compared to the forecasted evidentiary time series for the posterior period to gauge the effect the intervention or the suspected event had on the growth of the set of aquatic organisms. For example, the actual evidentiary time series and the forecasted evidentiary time series for the posterior period can be plotted together. If the actual evidentiary time series trends outside the posterior intervals (e.g., 95% intervals) of the forecasted evidentiary time series, then the trend can be statistically significant.

As an example, consider a computer graphical user interface plot of the actual evidentiary time series reflecting biomass estimates of the set of aquatic organisms in a fish farm enclosure (e.g., a net pen) over a past period (e.g., the past month). An observer (e.g., a fish farmer) of the plot can notice that recent biomass estimates from the biomass estimation system for the most recent week indicate that the growth trend has slowed or even reversed. The observer can infer from the plot that an event occurred in the aquaculture environment just before the time in the plot where the actual evidentiary time series begins trending in the unexpected direction. For the example, the event might be the escape of larger sexually mature fish from the fish farm enclosure. The observer can select (e.g., using appropriate computer input) a time point corresponding to the point in time and request a forecast of the evidentiary time series with respect to the selected time point. The selected time point can define the prior period and the posterior period. The plot can be updated, or a new plot generated that plots the actual evidentiary time series for the posterior period against the forecasted evidentiary time series for the posterior period. From this plot, the observer can see if the trend of the actual evidentiary time series it outside the bounds of the posterior intervals of the forecasted time series. If so, then the observer's suspicions that an event has occurred in the aquaculture environment that is affecting aquatic organism growth in the fish farm enclosure can be confirmed.

It should be noted that in the case where a forecast is requested based on a selected time point that divides the evidentiary time series and any reference time series in the prior period and the posterior period, there may be no determination 106 of whether a delayed processing timing has been met. Instead, the operations 108, 110, and 112 can be performed on request after receiving 102 the evidentiary time series and after receiving 104 any reference time series where the request specifies a time point that divides the evidentiary time series and any reference time series into the prior period and the posterior period.

In some variations, instead of a time point that divides time series into the prior and posterior periods being selected by a user with appropriate user input (e.g., mouse click, keyboard input, touch gesture input), a time point is selected automatically according to a computer-implemented algorithm. For example, the algorithm can select the time point corresponding to a predetermined amount of time in the past or based on when past interventions in the rearing process (e.g., a past feeding time when the nutrient composition of the feed was changed) were known to have occurred. A forecast can be generated based on that selected time point and a determination automatically made whether the actual evidentiary time series for the selected posterior period trends outside the bounds of the posterior intervals of the forecasted evidentiary time series for the selected posterior period. If so, an alert or notification can be automatically generated to inform a user of the statistically significant deviation from the forecast which can be caused by an event that is impacting the health of the aquatic organism in the fish farm enclosure. For example, the alert or notification can be an e-mail message, a text message, or by color coding computer graphical user interface plots to indicate a portion of the plot of the actual evidentiary time series that is a statistically significant deviation from the forecast.

In addition to or instead of displaying a plot in a computer graphical user interface, other actions 112 can be taken based on a forecast. Where there is a statistically significant deviation of the actual evidentiary time series from the forecasted evidentiary time series during the posterior period where the biomass estimates of the actual evidentiary time series are below the biomass estimates of the forecast, then an event that has impacted the health of the aquatic organisms in the aquaculture environment may have occurred. In this case, sea lice counts, body wound counts, or movement (swimming) patterns of the aquatic organisms obtained from a computer vision-based biomass estimation system for the relevant time period during the posterior period can be correlated with the actual biomass estimates from the biomass estimation system for the same time period. The correlation analysis can be performed automatically in response to detecting the statistically significant deviation where the biomass estimates of the actual evidentiary time series are below the biomass estimates of the forecast. If health metrics such as sea lice counts, body wound counts, or movement (swimming) patterns correlate with the low actual biomass estimates, then an alert or notification can be generated that indicates that the health of the aquatic organism in the aquaculture environment may be impacted. For example, if the sea lice counts are high during the relevant period, then the alert or notification can indicate that a sea lice infestation may be impacting aquatic organism health.

An alert or notification can be automatically generated when the aquatic organisms are ready for harvest. For example, the alert or notification can be generated when the actual biomass estimates of the evidentiary time series during the posterior period exceed a threshold biomass amount and the actual biomass estimates are within the forecast intervals of the forecasted time series (e.g., not a statistically significant deviation).

Example System

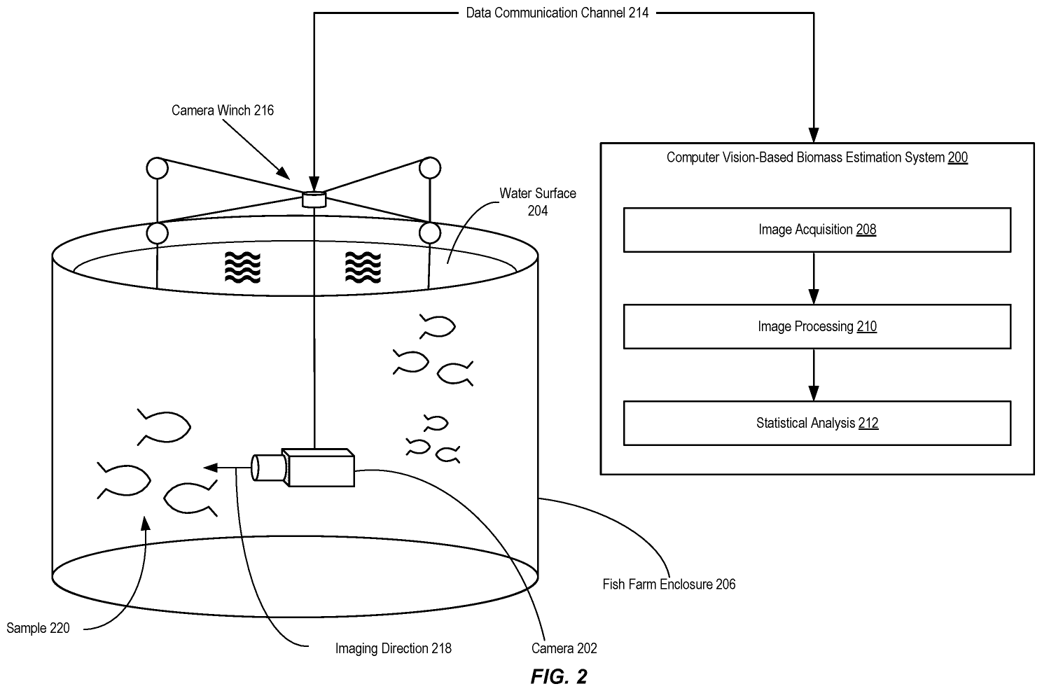

FIG. 2 depicts an example computer vision-based biomass estimation system 200 that is used in some variations. A monocular or stereo vision camera 202 is immersed under the water surface 204 in a fish farm enclosure 206. Camera 202 uses visible light to capture images or video of fish swimming freely in enclosure 206. The captured images or video provide pixel information from which quantitative information is extracted and analyzed for object recognition. System 200 may be implemented based on one or more computer systems such as, for example,

No particular type or configuration of camera 202 is required. In a possible implementation, camera 202 is an approximately 12-megapixel color or monochrome camera with a resolution of approximately 4096 pixels by 3000 pixels, and a frame rate of 1 to 8 frames per second. Although different cameras with different capabilities may be used according to the requirements of the implementation at hand.

The lens or lenses or camera 202 may be selected based on an appropriate baseline and focal length to capture images of fish swimming in front of camera 202 in enclosure 206 where fish are close enough to the lens(es) for proper pixel resolution and feature detection in the captured image, but far enough away from the lens or lenses such that the fish can fit entirely in the image or video frame. For example, an 8-millimeter focal length lens with high line pair count (lp/mm) can be used such that the pixels can be resolved. The baseline of camera 202 may have greater variance such as, for example, within the range of 6 to 12-millimeter baseline.

Enclosure 206 may be framed by a plastic or steel cage that provides a substantially conical, cubic, cylindrical, spherical, or hemispherical shape. Enclosure 206 may hold fish of a particular type (e.g., Atlantic salmon) depending on various factors such as the size of enclosure 206 and the maximum stocking density of the fish. For example, an enclosure 206 for Atlantic salmon may be 50 meters in diameter, 20-50 meters deep, and hold up to approximately 200,000 salmon assuming a maximum stocking density of 10 to 25 kg/m3. While enclosure 206 can be a net pen or sea-cage located in the open sea or open water, enclosure 206 can be a fish farm pond, tank, or other fish farm enclosure.

Camera 202 may be attached to winch system 216. Winch system 216 allows camera 202 to be relocated underwater in enclosure 206. This allows camera 202 to capture images or video of fish from different locations within enclosure 206. For example, winch 216 may allow camera 202 to move around the perimeter of enclosure 206 and at various depths within enclosure 206. Winch system 216 may also allow control of pan and tilt of camera 202. Winch system 216 may be operated manually by a human controller such as, for example, by directing user input to a winch control system located above water surface 204.

Winch system 216 may operate autonomously according to a winch control program configured to adjust the location of camera 202 within enclosure 206. The autonomous winch control system may adjust the location of camera 202 according to a series of predefined or pre-programmed adjustments or according to detected signals in enclosure 206 that indicate better or more optimal locations within enclosure 206 for capturing images or video of fish relative a current position or orientation of camera 202. A variety of signals may be used such as, for example, machine learning and computer visions techniques applied to images or video captured by camera 202 to detect schools or clusters of fish currently distant from camera 202 such that a location that is closer to the school or cluster can be determined and the location, tilt, or pan of camera 202 adjusted to capture more suitable images of the fish. The same techniques may be used to automatically determine that camera 202 should remain or linger in a current location or orientation because camera 202 is currently in a good position to capture suitable images of fish. Instead of using winch 216 to position camera 202 within enclosure 206, the housing of camera 202 may include or be attached to underwater propulsion mechanisms such as propellers or water jets. In this case, camera 202 may move within enclosure 206 autonomously as in a self-driving fashion. Also in this case, camera 102 may include components and software to control autonomous navigation such as underwater LiDAR and computer vision-software.

While camera 202 may operate using natural light (sunlight), an ambient lighting apparatus may be attached to camera 202 or otherwise located within enclosure 206. For example, the light apparatus may illuminate a volume of water in front of camera 202 with ambient lighting in the blue-green spectrum (450 nanometers to 570 nanometers). This spectrum may be used to increase the length of the daily sample period during which useful images of fish in enclosure 106 may be captured. For example, depending on the current season (e.g., winter), time of day (e.g., sunrise or sunset), and latitude of enclosure 206, only a few hours during the middle of the day may be suitable for capturing useful images without using ambient lighting. This daily period may be extended with ambient lighting. Use of fluorescent, LED, or other artificial lighting is also possible.

Although not shown in FIG. 2, a mechanical feed system that is connected by physical pipes to enclosure 206 may be present in the aquaculture environment. The feed system may deliver food pellets via the pipes in doses to the fish in enclosure 206. The feed system may include other components such as a feed blower connected to an air cooler which is connected to an air controller and a feed doser which is connected to a feed selector that is connected to the pipes to enclosure 206.

Computer vision-based biomass estimation system 200 includes various functional modules including image acquisition 208, image processing 210, and statistical analysis 212. Digital images or video captured by camera 202 may be sent via data communication channel 214 to system 200. Data communication channel 214 can be a wired or wireless data communication channel. For example, data communication channel 214 can be a wired fiber data communication channel or a wireless data communication channel such as one based on a wireless data communication standard such as, for example, a satellite data communication standard or a standard in the IEEE 802.11 family of wireless standards.

It is also possible for system 200 to be a component of camera 202. In this case, data communication channel 214 is not needed to connect camera 202 to system 200. Instead, data communication channel 214 may be used to connect camera 202 to another system (not shown) that processes the results produced by system 200.

Regardless of if data communication channel 214 is used to convey images, video, or results produced by system 200, the results produced by system 200 may be provided to another system such as, for example, a web application system that provides a web browser-based or a portable computing device-based graphical user interface at client computing devices. The graphical user interface may visually present the results produced by system 200 or information derived therefrom such as in a web dashboard or the like. The results produced by system 200 or the information derived therefrom presented in the graphical user interface may include a measurement of the mass of fish in enclosure 206 (“fish mass measurement”), a count of fish in enclosure 206 (“fish count”), or a direct estimate of the biomass of fish in enclosure 206 (“direct fish biomass estimate”).

As used herein, unless the context clearly indicates otherwise, the term “biomass estimate” and “biomass estimation” broadly encompasses any of a fish mass measurement, a fish count, or a direct fish biomass estimate of an individual fish or of two or more fish (e.g., of all the fish in sample 220 or of all the fish in enclosure 206). A biomass estimate can be an average, a mean, a probability distribution, or other statistical or mathematical combination of a set of biomass estimates. For example, a biomass estimate of sample 220 can be computed as a statistical or mathematical combination of individual biomass estimates of fish in sample 220. As another example, a biomass estimate of enclosure 206 can be generated by extrapolating a biomass estimate of sample 220 to the entire enclosure 206.

Image acquisition 208 includes receiving the images or video captured by camera 202 and storing the images or video on a storage media (e.g., storage media of system 200) for further processing by image processing 210 and statistical analysis 212. Image acquisition 208 may perform some basic filtering of images or video such as discarding unusable images or video such as, for example, images or video frames that do not appear to contain any aquatic organisms or are of poor quality because of inadequate lighting or because camera 202 was in motion when the images or video was captured resulting in blurry images or video.

Image acquisition 208 may also perform cataloging of the images and video captured by camera 202. Cataloging may include associating captured images or video with metadata reflecting the situation or environment in enclosure 206 in which or at the time the images or video were captured by camera 202. Image acquisition 208 may associate captured images or video with metadata in storage media (e.g., storage media of system 200). Such metadata may include, but is not limited to, dates and times of when associated images or video were captured by camera 202 and position information for camera 202 when associated images or video were captured. The dates and times can be provided by a clock either of camera 202 or system 200. The position information can be provided by a global positioning satellite sensor affixed to camera 202, provided by camera winch system 216, or provided by an accelerator sensor of camera 202 such as, for example, a microelectromechanical system sensor (MEMS).

However provided, the position information may indicate the position of camera 202 underwater in enclosure 206 in one or more spatial dimensions. The position information may indicate the position of camera 202 in the volume of water within enclosure 206. For example, the position information may indicate one or more coordinates in a first plane and a coordinate in a second plane that is perpendicular to the first plane. For example, the first plane may be parallel to water surface 204. The position information, then, may indicate an x-axis coordinate and a y-axis coordinate in the first plane and a z-axis coordinate in the second plane. For example, the x-axis coordinate, and the y-axis coordinate may correspond to the position of camera 202 at water surface 204 and the z-axis coordinate may correspond to the depth of camera 202 underwater at the position of camera 202 at water surface 204 corresponding to the x-axis coordinate and the y-axis coordinate. In this example, the position of camera 202 within enclosure 206 is controllable by camera winch 216 in all three dimensions x, y, and z. However, camera winch 216 may allow positioning of camera 202 within enclosure 206 in just one or two of those dimensions. In this case, the dimension or dimensions that are not controllable by winch 116 may be fixed or otherwise predetermined.

The position information may also indicate the imaging orientation of camera 202 within enclosure 206. In particular, the position information may indicate the direction of the lens of camera 202 when images or video associated with the position information were captured. For example, the position information may indicate a compass heading or an angular position. Here, the compass heading or angular position may be with respect to a plane parallel with the imaging direction of the lens where the imaging direction of the lens is perpendicular to the plane of the lens. For example, in system 200, imaging direction 218 of lens of camera 202 is depicted as substantially parallel to water surface 204. However, imaging direction 218 of lens of camera 202 may instead be substantially perpendicular to water surface 204 such as, for example, if camera 202 is positioned nearer to the bottom of enclosure 206 and imaging direction 218 is towards water surface 204 or if camera 202 is positioned nearer to water surface 204 and imaging direction 218 is towards the bottom of enclosure 206.

The position information may also indicate a pitch angle of imaging direction 218 relative to a plane parallel to water surface 204 or relative to a plane perpendicular to water surface 204. For example, the pitch angle of imaging direction 218 as depicted in FIG. 2 may be zero degrees relative to a plane parallel to water surface 204 or ninety degrees relative to a plane perpendicular to water surface 204. Depending on the pitch of image direction 218, the pitch angle may range between −90 degrees and +90 degrees or equivalently between 0 and 180 degrees.

Reference herein to the “position” of camera 202 may encompass any one of the following or a combination two or more thereof: an x-axis position of camera 202, a y-axis position of camera 202, a z-axis position of camera 102, a compass heading of imaging direction 218 of camera 202, an angular position of imaging direction 218 of camera 202, a pitch angle of imaging direction 218 of camera 202, a longitudinal position of camera 202, a latitudinal position of camera 202, an elevation of camera 202, or a underwater depth of camera 202.

The volumetric size of enclosure 206 and the number of fish in enclosure 206 may be such that, at a given position in enclosure 206, camera 202 cannot capture sufficiently high-quality images or video of all the fish in enclosure 206 for use by system 200 to compute an accurate biomass estimate of enclosure 206. Characteristics of the lens or lenses of camera 202 and the requirements of the imaging application at hand such as focal length, aperture, maximum aperture, and depth of field may limit the volume of water within enclosure 206 of which camera 202 at a given position can capture sufficiently high-quality images or video. As a result, the images or video captured by camera 202 at a given position may be only a sample 220 of all fish in enclosure 206.

As used herein, a “sample” as in, for example, sample 220, refers to one or more images or video of one or more fish in enclosure 206 captured by camera 202 and processed by system 100 to generate a biomass estimate based on sample 220.

Sample 220 may not be representative of the entire fish population in enclosure 206. In other words, sample 220 may have a bias. The bias may be severe. Severe bias can cause substantial overestimation or underestimation when sample 220 is used by system 200 to generate a biomass estimate of enclosure 206. Various situational and environment conditions in enclosure 204 can contribute to the bias of sample 220. Such conditions may include the position of camera 202 when sample 220 is captured and the location and spatial distribution of fish within the enclosure 204 when sample 220 is captured.

To attempt to reduce bias, sample 220 may be captured when the fish in enclosure 206 are being fed. This tends to reduce the spatial distribution of the fish population in enclosure 206 as the fish tend to congregate around where the feed is being dispensed into enclosure 206 by a mechanical feed dispenser above, below, or at water surface 204. Even so, sample 220 captured at feeding time may still have significant bias. For example, sample 220 may include mostly larger more powerful fish that are able to push out the smaller weaker fish from the area in the enclosure 206 where the feed is being dispensed, or sample 220 may omit fish that are satiated or sick or otherwise not feeding at the time.

For fish mass measurement of a target fish, statistical analysis 212 may use a polynomial, linear, power curve, or other mathematical model for computing a fish weight (mass) of the target fish based on one or more fish size parameters for the target fish Image processing 210 may identify the target fish in sample 220. For example, image processing 210 may use machine learning-aided image segmentation to identify portions of images or video frames that contain an image of a fish.

In some implementations, image processing 210 incorporates a deep convolutional neural network to aid in segmentation of target fish from sample 220. Image processing 220 may then use two-dimensional (2D) or three-dimensional (3D) image processing techniques to determine from sample 220 the one or more fish size parameters of the target fish for input to the model. A fish size parameter can include an estimated length, area, width, or perimeter of the target fish. The model may be target fish species-specific and may incorporate a bend model to account for a bend of the target fish in sample 220 in case the body of the target fish is not straight in sample 220. Multiple fish mass measurements of multiple target fish identified in sample 220 may be determined over a period.

Various computer vision techniques may be employed by image processing 210 to obtain a fish count of sample 220. Such computer vision techniques may include one or more of the following methods: neural network, data fitting, area counting, curve evolution, fish localization, image thinning, connected component, or object tracking.

For direct fish biomass estimation of a target fish, statistical analysis 212 can compute a weight (mass) of a target fish directly by its volume and its density (mass=volume multiplied by density). The density of the target fish can be predetermined such as by the particular species of the target fish. The volume of the target fish can be determined by image processing 210 from sample 220 using various techniques including computer vision technology such as 2D or 3D image processing techniques aided by deep learning such as a convolutional neural network. The computer vision techniques may be aided by laser scanning technology. For example, a LiDAR suitable for underwater use may be affixed to camera 202 for laser scanning fish in imaging direction 218. For example, a laser scanner in combination with a monocular camera 202 may be used. The laser scanner projects structural light onto the fish and 2D or 3D cartesian coordinates of the fish's surface can be determined based on sample 220 by image processing 210 to represent the fish's shape.

System 200 may flag images or video frames captured by camera 202 that are not suitable for use by system 100 for generating biomass estimates. In particular, system 200 may employ an algorithm to identify images or video frames captured by camera 202 based on intrinsic characteristics of the images or frames. For example, the algorithm may flag images or video frames that are blurry or that have insufficient brightness. System 200 may exclude the identified images or video frames from a set of images or video frames that are used by system 200 to generate biomass estimates.

While in some variations system 200 is a computer vision-based biomass estimation system, an echo-sounder-based biomass estimation system may be used. In this case, an acoustic pulse is regularly transmitted toward fish in enclosure 206. The return signals are analyzed after the pulse has bounced (reflected) off the fish. Time intervals between pulse transmission and reception, as well as the intensity of the return signals, may be analyzed to determine a fish count or an estimated weight or density. Evidentiary times series data can be obtained from a computer vision-based biomass estimation system, an echo sounder-based biomass estimation, or

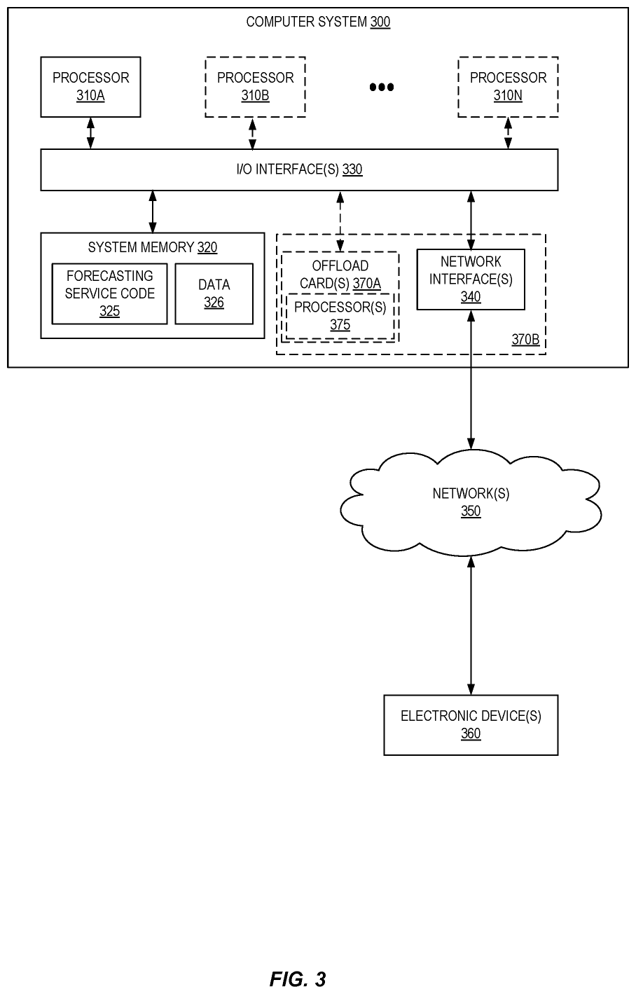

In some variations, a system that implements a portion or all of the techniques described herein can include a general-purpose computer system, such as the computer system 300 illustrated in FIG. 3, that includes, or is configured to access, one or more computer-accessible media. In the illustrated embodiment, the computer system 300 includes one or more processors 310 coupled to a system memory 320 via an input/output (I/O) interface 330. The computer system 300 further includes a network interface 340 coupled to the I/O interface 330. While FIG. 3 shows the computer system 300 as a single computing device, in various embodiments the computer system 300 can include one computing device or any number of computing devices configured to work together as a single computer system 300.

In various embodiments, the computer system 300 can be a uniprocessor system including one processor 310, or a multiprocessor system including several processors 310 (e.g., two, four, eight, or another suitable number). The processor(s) 310 can be any suitable processor(s) capable of executing instructions. For example, in various embodiments, the processor(s) 310 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 310 can commonly, but not necessarily, implement the same ISA.

The system memory 320 can store instructions and data accessible by the processor(s) 310. In various embodiments, the system memory 320 can be implemented using any suitable memory technology, such as random-access memory (RAM), static RAM (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within the system memory 320 as biomass estimation code 325 (e.g., executable to implement, in whole or in part, to implement the biomass estimation techniques disclosed herein) and data 326.

In some embodiments, the I/O interface 330 can be configured to coordinate I/O traffic between the processor 310, the system memory 320, and any peripheral devices in the device, including the network interface 340 and/or other peripheral interfaces (not shown). In some embodiments, the I/O interface 330 can perform any necessary protocol, timing, or other data transformations to convert data signals from one component (e.g., the system memory 320) into a format suitable for use by another component (e.g., the processor 310). In some embodiments, the I/O interface 330 can include support for devices attached through various types of peripheral buses, such as a variant of the Peripheral Component Interconnect (PCI) bus standard or the Universal Serial Bus (USB) standard, for example. In some embodiments, the function of the I/O interface 330 can be split into two or more separate components, such as a north bridge and a south bridge, for example. Also, in some embodiments, some or all of the functionality of the I/O interface 330, such as an interface to the system memory 320, can be incorporated directly into the processor 310.

The network interface 340 can be configured to allow data to be exchanged between the computer system 300 and other devices 360 attached to a network or networks 350, such as other computer systems or devices as illustrated other figures, for example. In various embodiments, the network interface 340 can support communication via any suitable wired or wireless general data networks, such as types of Ethernet network, for example. Additionally, the network interface 340 can support communication via telecommunications/telephony networks, such as analog voice networks or digital fiber communications networks, via storage area networks (SANs), such as Fibre Channel SANs, and/or via any other suitable type of network and/or protocol.

In some embodiments, the computer system 300 includes one or more offload cards 370A or 370B (including one or more processors 375, and possibly including the one or more network interfaces 340) that are connected using the I/O interface 330 (e.g., a bus implementing a version of the Peripheral Component Interconnect-Express (PCI-E) standard, or another interconnect such as a QuickPath interconnect (QPI) or UltraPath interconnect (UPI)). For example, in some embodiments the computer system 300 can act as a host electronic device (e.g., operating as part of a hardware virtualization service) that hosts compute resources such as compute instances, and the one or more offload cards 370A or 370B execute a virtualization manager that can manage compute instances that execute on the host electronic device. As an example, in some embodiments the offload card(s) 370A or 370B can perform compute instance management operations, such as pausing and/or un-pausing compute instances, launching and/or terminating compute instances, performing memory transfer/copying operations, etc. These management operations can, in some embodiments, be performed by the offload card(s) 370A or 370B in coordination with a hypervisor (e.g., upon a request from a hypervisor) that is executed by the other processors 310A-610N of the computer system 300. However, in some embodiments the virtualization manager implemented by the offload card(s) 370A or 370B can accommodate requests from other entities (e.g., from compute instances themselves), and cannot coordinate with (or service) any separate hypervisor.

In some embodiments, the system memory 320 can be one embodiment of a computer-accessible medium configured to store program instructions and data as described above. However, in other embodiments, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computer system 300 via the I/O interface 330. A non-transitory computer-accessible storage medium can also include any volatile or non-volatile media such as RAM (e.g., SDRAM, double data rate (DDR) SDRAM, SRAM, etc.), read only memory (ROM), etc., that can be included in some embodiments of the computer system 300 as the system memory 320 or another type of memory. Further, a computer-accessible medium can include transmission media or signals such as electrical, electromagnetic, or digital signals, conveyed via a communication medium such as a network and/or a wireless link, such as can be implemented via the network interface 340.

Various embodiments discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most embodiments use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In embodiments using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate embodiments can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

### Terminology

In the preceding description, various embodiments are described. For purposes of explanation, specific configurations and details are set forth to provide a thorough understanding of the embodiments. However, it will also be apparent to one skilled in the art that the embodiments can be practiced without the specific details. Furthermore, well-known features can be omitted or simplified in order not to obscure the embodiment being described.

Bracketed text and blocks with dashed borders (e.g., large dashes, small dashes, dot-dash, and dots) are used herein to illustrate optional operations that add additional features to some embodiments. However, such notation should not be taken to mean that these are the only options or optional operations, or that blocks with solid borders are not optional in certain embodiments.

Unless the context clearly indicates otherwise, the term “or” is used in the foregoing specification and in the appended claims in its inclusive sense (and not in its exclusive sense) so that when used, for example, to connect a list of elements, the term “or” means one, some, or all of the elements in the list.

Unless the context clearly indicates otherwise, the terms “comprising,” “including,” “having,” “based on,” “encompassing,” and the like, are used in the foregoing specification and in the appended claims in an open-ended fashion, and do not exclude additional elements, features, acts, or operations.

Unless the context clearly indicates otherwise, conjunctive language such as the phrase “at least one of X, Y, and Z,” is to be understood to convey that an item, term, etc. may be either X, Y, or Z, or a combination thereof. Thus, such conjunctive language is not intended to require by default implication that at least one of X, at least one of Y, and at least one of Z to each be present.

Unless the context clearly indicates otherwise, as used in the foregoing detailed description and in the appended claims, the singular forms “a,” “an,” and “the” are intended to include the plural forms as well.

Unless the context clearly indicates otherwise, in the foregoing detailed description and in the appended claims, although the terms first, second, etc. are, in some instances, used herein to describe various elements, these elements should not be limited by these terms. These terms are only used to distinguish one element from another. For example, a first computing device could be termed a second computing device, and, similarly, a second computing device could be termed a first computing device. The first computing device and the second computing device are both computing devices, but they are not the same computing device.

In the foregoing specification, the techniques have been described with reference to numerous specific details that may vary from implementation to implementation. The specification and drawings are, accordingly, to be regarded in an illustrative rather than a restrictive sense.

What is claimed is:

1. A computer-implemented method comprising:
receiving an evidentiary time series, the evidentiary time series reflecting biomass estimates of aquatic organisms in an aquaculture environment made by a biomass estimation system;
learning a time-series model based on a prior period of the evidentiary time series;
using the learned time-series model to generate a forecast of the evidentiary time series for a posterior period;
causing a computer graphical user interface to be displayed that plots the evidentiary time series for at least a portion of the prior period with the forecast of the evidentiary time series for the posterior period; and
wherein the method is performed by one or more electronic devices.

2. The method of claim 1, wherein the biomass estimation system is a computer vision-based biomass estimation system that generates biomass estimates of the evidentiary time series based on applying computer vision techniques to images or video captured by a camera immersed underwater in the aquaculture environment.

3. The method of claim 1, wherein the time-series model is a Bayesian time-series model.

4. The method of claim 1, further comprising:
receiving a set of one or more reference time series; and
learning the time-series model based on the prior period of the set of one or more reference time series.

5. The method of claim 4, wherein a reference time series of the set of one or more reference time series is based on a biological model of fish growth.

6. The method of claim 4, wherein a reference time series of set of one or more reference time series is based on a feed growth-model.

7. The method of claim 4, wherein a reference time series of the set of one or more reference time series reflects biomass estimates of aquatic organisms in a different aquaculture environment than the aquaculture environment

8. The method of claim 1, further comprising:
determining that the evidentiary time series for the posterior period is a statistically significant deviation from the forecast of the evidentiary time series for the posterior period; and
generating an alert or a notification about the statistically significant deviation.

9. The method of claim 1, further comprising:
determining that the evidentiary time series for the posterior period is a statistically significant deviation below the forecast of the evidentiary time series for the posterior period;
correlating the statistically significant deviation with a sea lice count or a body wound count for aquatic organisms in the aquaculture environment for a period comprising a least a portion of the prior period or the posterior period; and
generating an alert or a notification about health of the aquatic organisms in the aquaculture environment.

10. The method of claim 1, further comprising:
receiving a set of one or more reference time series; and
using the learned time-series model and set of one or more reference time series for the posterior period to generate the forecast of the evidentiary time series for a posterior period.

11. A system comprising:
one or more electronic devices to implement a biomass estimation system;
one or more electronic devices to implement a forecasting system, the forecasting system comprising instructions which when execute cause the forecasting system to:
receive an evidentiary time series, the evidentiary time series reflecting biomass estimates of aquatic organisms in an aquaculture environment made by a biomass estimation system;
learn a time-series model based on a prior period of the evidentiary time series;
use the learned time-series model to generate a forecast of the evidentiary time series for a posterior period; and
cause a computer graphical user interface to be displayed that plots the evidentiary time series for at least a portion of the prior period with the forecast of the evidentiary time series for the posterior period.

12. The system of claim 11, wherein the biomass estimation system is a computer vision-based biomass estimation system that is configured to generate biomass estimates of the evidentiary time series based on applying computer vision techniques to images or video captured by a camera immersed underwater in the aquaculture environment.

13. The system of claim 11, wherein the time-series model is a Bayesian time-series model.

14. The system of claim 11, the forecasting system further comprising instructions which when execute cause the forecasting system to:
receive a set of one or more reference time series; and
learn the time-series model based on the prior period of the set of one or more reference time series.

15. The system of claim 14, wherein a reference time series of the set of one or more reference time series is based on a biological model of fish growth.

16. The system of claim 14, wherein a reference time series of set of one or more reference time series is based on a feed growth-model.

17. The system of claim 14, wherein a reference time series of the set of one or more reference time series reflects biomass estimates of aquatic organisms in a different aquaculture environment than the aquaculture environment

18. The system of claim 11, the forecasting system further comprising instructions which when execute cause the forecasting system to:
determine that the evidentiary time series for the posterior period is a statistically significant deviation from the forecast of the evidentiary time series for the posterior period; and
generate an alert or a notification about the statistically significant deviation.

19. The system of claim 11, the forecasting system further comprising instructions which when execute cause the forecasting system to:
determine that the evidentiary time series for the posterior period is a statistically significant deviation below the forecast of the evidentiary time series for the posterior period;
correlate the statistically significant deviation with a sea lice count or a body wound count for aquatic organisms in the aquaculture environment for a period comprising a least a portion of the prior period or the posterior period; and
generate an alert or a notification about health of the aquatic organisms in the aquaculture environment.

20. The system of claim 11, the forecasting system further comprising instructions which when execute cause the forecasting system to:
receive a set of one or more reference time series; and
use the learned time-series model and set of one or more reference time series for the posterior period to generate the forecast of the evidentiary time series for a posterior period.
